(19) United States
(12) Patent Application Publication
(10) Pub. No.: US 2024/0311774 A1
(43) Pub. Date: Sep. 19, 2024

(54) INFORMATION PROCESSING DEVICE, INFORMATION PROCESSING METHOD, AND A NON-TRANSITORY STORAGE MEDIUM

(71) Applicant: TOYOTA JIDOSHA KABUSHIKI KAISHA, Toyota-shi (JP)

(72) Inventors: Yu HAMADA, Nagoya-shi (JP); Kenta KAWASHIMA, Nagoya-shi (JP); Yuichi MUKASA, Kawaguchi-shi (JP); Keisuke KONDO, Nagoya-shi (JP); Yohei NAKANISHI, Nagoya-shi (JP)

(73) Assignee: TOYOTA JIDOSHA KABUSHIKI KAISHA, Toyota-shi (JP)

(21) Appl. No.: 18/602,439

(22) Filed: Mar. 12, 2024

(30) Foreign Application Priority Data
Mar. 17, 2023 (JP) 2023-042494

(51) Int. Cl. G06Q 10/20; G06Q 30/0283; G06Q 30/0645

(52) U.S. Cl. CPC G06Q 10/20; G06Q 30/0283; G06Q 30/0645

(57) ABSTRACT

A controller is configured to acquire a scheduled visit period in which a user is scheduled to visit a facility at which the user is able to have a vehicle maintained. The controller is configured to determine whether a specific item is present among a plurality of maintenance items for the vehicle. The specific item is a maintenance item for which a recommended period in which it is recommended to have the vehicle maintained is included within a predetermined period that includes the scheduled visit period. The recommended period is a period that does not overlap the scheduled visit period. The controller is configured to: acquire item information about a maintenance content of the specific item when the specific item is present; and determine, based on the item information, whether maintenance corresponding to the specific item is to be performed in the scheduled visit period or in the recommended period.

### CROSS-REFERENCE TO RELATED APPLICATION

This application claims priority to Japanese Patent Application No. 2023-042494 filed on Mar. 17, 2023 incorporated herein by reference in its entirety.

### BACKGROUND

### 1. Technical Field

The present disclosure relates to an information processing device, an information processing method, and a non-transitory storage medium.

### 2. Description of Related Art

Japanese Unexamined Patent Application Publication No. 2021-157455 (JP 2021-157455 A) discloses a vehicle management system. The vehicle management system disclosed in JP 2021-157455 A calculates damage to components of a vehicle based on values measured by sensors provided in the vehicle, and stores a history of damage. The vehicle management system predicts a travel distance at which damage in the future becomes equal to or more than a predetermined threshold based on the travel distance of the vehicle and the history of damage.

### SUMMARY

The present disclosure provides an information processing device, an information processing method, and a non-transitory storage medium that determine a period that is suitable for a user to have a vehicle maintained.

A first aspect of the present disclosure provides an information processing device including a controller. The controller is configured to acquire a scheduled visit period in which a user is scheduled to visit a facility at which the user is able to have a vehicle maintained. The controller is configured to determine whether a specific item is present among a plurality of maintenance items for the vehicle. The specific item is a maintenance item for which a recommended period in which it is recommended to have the vehicle maintained is included within a predetermined period that includes the scheduled visit period. The recommended period is a period that does not overlap the scheduled visit period. The controller is configured to: acquire item information about a maintenance content of the specific item when the specific item is present; and determine, based on the item information, whether maintenance corresponding to the specific item is to be performed in the scheduled visit period or in the recommended period.

In the information processing device according to the first aspect of the present disclosure, the item information may include information on a maintenance cost required for the maintenance corresponding to the specific item. The controller may be configured to, in a case where the recommended period arrives earlier than the scheduled visit period, determine to perform the maintenance corresponding to the specific item in the scheduled visit period when the maintenance cost is equal to or more than a first threshold. The controller may be configured to, in the case where the recommended period arrives earlier than the scheduled visit period, determine to perform the maintenance corresponding to the specific item in the recommended period when the maintenance cost is less than the first threshold.

In the information processing device according to the first aspect of the present disclosure, the predetermined period may be set such that a length of a period before a start period of the scheduled visit period is longer as the maintenance cost is higher.

In the information processing device according to the first aspect of the present disclosure, the item information may include information on a maintenance cost required for the maintenance corresponding to the specific item. The controller may be configured to, in a case where the recommended period arrives later than the scheduled visit period, determine to perform the maintenance corresponding to the specific item in the recommended period when the maintenance cost is equal to or more than a second threshold. The controller may be configured to, in the case where the recommended period arrives later than the scheduled visit period, determine to perform the maintenance for the specific item in the scheduled visit period when the maintenance cost is less than the second threshold.

In the information processing device according to the first aspect of the present disclosure, the item information may include information on an importance degree of the maintenance corresponding to the specific item. The controller may be configured to, in a case where the recommended period arrives earlier than the scheduled visit period, determine to perform the maintenance corresponding to the specific item in the recommended period when the importance degree is equal to or more than a third threshold. The controller may be configured to, in the case where the recommended period arrives earlier than the scheduled visit period, determine to perform the maintenance corresponding to the specific item in the scheduled visit period when the importance degree is less than the third threshold.

In the information processing device according to the first aspect of the present disclosure, the item information may include information on an importance degree of the maintenance corresponding to the specific item. The controller may be configured to, in a case where the recommended period arrives later than the scheduled visit period, determine to perform the maintenance corresponding to the specific item in the scheduled visit period when the importance degree is equal to or more than a fourth threshold. The controller may be configured to, in the case where the recommended period arrives later than the scheduled visit period, determine to perform the maintenance corresponding to the specific item in the recommended period when the importance degree is less than the fourth threshold.

In the information processing device according to the first aspect of the present disclosure, the predetermined period may be set such that a length of a period after an end period of the scheduled visit period is longer as the importance degree is higher.

In the information processing device according to the first aspect of the present disclosure, the scheduled visit period may be a period in which the vehicle is defined to undergo a legal inspection.

In the information processing device according to the first aspect of the present disclosure, the vehicle may be a vehicle leased from a leasing company to the user. The scheduled visit period may be a period in which the user is scheduled to bring the vehicle to a facility associated with the leasing company.

A second aspect of the present disclosure provides an information processing method to be executed by a computer. The information processing method includes: acquiring a scheduled visit period in which a user is scheduled to visit a facility at which the user is able to have a vehicle maintained; and determining whether a specific item is present among a plurality of maintenance items for the vehicle. The specific item is a maintenance item for which a recommended period in which it is recommended to have the vehicle maintained is included within a predetermined period that includes the scheduled visit period. The recommended period is a period that does not overlap the scheduled visit period. The information processing method further includes: acquiring item information about a maintenance content of the specific item when the specific item is present; and determining, based on the item information, whether maintenance corresponding to the specific item is to be performed in the scheduled visit period or in the recommended period.

In the information processing method according to the second aspect of the present disclosure, the item information may include information on a maintenance cost required for the maintenance corresponding to the specific item. The determining whether maintenance corresponding to the specific item is to be performed in the scheduled visit period or in the recommended period may include, in a case where the recommended period arrives earlier than the scheduled visit period, determining to perform the maintenance corresponding to the specific item in the scheduled visit period when the maintenance cost is equal to or more than a first threshold. The determining whether maintenance corresponding to the specific item is to be performed in the scheduled visit period or in the recommended period may include, in the case where the recommended period arrives earlier than the scheduled visit period, determining to perform the maintenance corresponding to the specific item in the recommended period when the maintenance cost is less than the first threshold.

In the information processing method according to the second aspect of the present disclosure, the predetermined period may be set such that a length of a period before a start period of the scheduled visit period is longer as the maintenance cost is higher.

In the information processing method according to the second aspect of the present disclosure, the item information may include information on a maintenance cost required for the maintenance corresponding to the specific item. The determining whether maintenance corresponding to the specific item is to be performed in the scheduled visit period or in the recommended period may include, in a case where the recommended period arrives later than the scheduled visit period, determining to perform the maintenance corresponding to the specific item in the recommended period when the maintenance cost is equal to or more than a second threshold. The determining whether maintenance corresponding to the specific item is to be performed in the scheduled visit period or in the recommended period may include, in the case where the recommended period arrives later than the scheduled visit period, determining to perform the maintenance for the specific item in the scheduled visit period when the maintenance cost is less than the second threshold.

In the information processing method according to the second aspect of the present disclosure, the item information may include information on an importance degree of the maintenance corresponding to the specific item. The determining whether maintenance corresponding to the specific item is to be performed in the scheduled visit period or in the recommended period may include, in a case where the recommended period arrives earlier than the scheduled visit period, determining to perform the maintenance corresponding to the specific item in the recommended period when the importance degree is equal to or more than a third threshold. The determining whether maintenance corresponding to the specific item is to be performed in the scheduled visit period or in the recommended period may include, in the case where the recommended period arrives earlier than the scheduled visit period, determining to perform the maintenance corresponding to the specific item in the scheduled visit period when the importance degree is less than the third threshold.

In the information processing method according to the second aspect of the present disclosure, the item information may include information on an importance degree of the maintenance corresponding to the specific item. The determining of whether maintenance corresponding to the specific item is to be performed in the scheduled visit period or in the recommended period may include, in a case where the recommended period arrives later than the scheduled visit period, determining to perform the maintenance corresponding to the specific item in the scheduled visit period when the importance degree is equal to or more than a fourth threshold. The determining of whether maintenance corresponding to the specific item is to be performed in the scheduled visit period or in the recommended period may include, in the case where the recommended period arrives later than the scheduled visit period, determining to perform the maintenance corresponding to the specific item in the recommended period when the importance degree is less than the fourth threshold.

In the information processing method according to the second aspect of the present disclosure, the predetermined period may be set such that a length of a period after an end period of the scheduled visit period is longer as the importance degree is higher.

In the information processing method according to the second aspect of the present disclosure, the scheduled visit period may be a period in which the vehicle is defined to undergo a legal inspection.

In the information processing method according to the second aspect of the present disclosure, the vehicle may be a vehicle leased from a leasing company to the user. The scheduled visit period may be a period in which the user is scheduled to bring the vehicle to a facility associated with the leasing company.

A third aspect of the present disclosure provides a non-transitory storage medium configured to store instructions that are executable by one or more processors and that cause the one or more processors to execute the following functions. The functions include: acquiring a scheduled visit period in which a user is scheduled to visit a facility at which the user is able to have a vehicle maintained; and determining whether a specific item is present among a plurality of maintenance items for the vehicle. The specific item being a maintenance item for which a recommended period in which it is recommended to have the vehicle maintained is included within a predetermined period that includes the scheduled visit period. The recommended period being a period that does not overlap the scheduled visit period. The functions further include acquiring item information about a maintenance content of the specific item when the specific item is present, and determining, based on the item information, whether maintenance corresponding to the specific item is to be performed in the scheduled visit period or in the recommended period.

In the non-transitory storage medium according to the third aspect of the present disclosure, the item information may include information on a maintenance cost required for the maintenance corresponding to the specific item. The determining of whether maintenance corresponding to the specific item is to be performed in the scheduled visit period or in the recommended period may include, in a case where the recommended period arrives earlier than the scheduled visit period, determining to perform the maintenance corresponding to the specific item in the scheduled visit period when the maintenance cost is equal to or more than a first threshold. The determining of whether maintenance corresponding to the specific item is to be performed in the scheduled visit period or in the recommended period may include, in the case where the recommended period arrives earlier than the scheduled visit period, determining to perform the maintenance corresponding to the specific item in the recommended period when the maintenance cost is less than the first threshold.

According to the present disclosure, it is possible to determine a period that is suitable for a user to have a vehicle maintained.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 illustrates a schematic configuration of a notification system;

FIG. 2 is a first diagram illustrating a time line of a recommended date and a scheduled visit date;

FIG. 3 is a second diagram illustrating a time line of the recommended date and the scheduled visit date;

FIG. 4 is a block diagram schematically illustrating an example of the functional configuration of a management server;

FIG. 5 illustrates an example of the configuration of a table for vehicle information held in a vehicle information database;

FIG. 6 illustrates an example of the configuration of a table for user information held in a user information database;

FIG. 7 illustrates an example of the configuration of a table for item information held in an item information database;

FIG. 8 is a flowchart of a first process to be executed by a controller of the management server; and

FIG. 9 is a flowchart of a second process to be executed by the controller of the management server.

### DETAILED DESCRIPTION OF EMBODIMENTS

A case where a user is scheduled to visit a facility (hereinafter occasionally referred to as a “maintenance facility”) at which vehicles can be maintained is assumed. Here, the user does not necessarily have his/her vehicle maintained in a period (hereinafter occasionally referred to as a “scheduled visit period”) in which the user is scheduled to visit the maintenance facility. For example, when the maintenance facility also serves as a different facility, the user may visit the maintenance facility for a purpose other than maintenance of the vehicle. On the other hand, it is occasionally recommended that the vehicle should be maintained in a period that does not overlap the scheduled visit period. In this case, the user may move the vehicle in order to have the vehicle maintained in a period (hereinafter occasionally referred to as a “recommended period”) in which it is recommended that the vehicle should undergo maintenance and that does not overlap the scheduled visit period, even if the user is scheduled to visit the maintenance facility at which vehicles can be maintained. This requires the user to move the vehicle twice totally, which may be inconvenient for the user. A first aspect of the present disclosure provides an information processing device that addresses such an issue.

As described above, the information processing device determines which of the scheduled visit period and the recommended period the maintenance corresponding to the specific item is to be performed in. Consequently, the maintenance corresponding to the specific item may be performed on a day included in the scheduled visit period, rather than on a day included in the recommended period. Therefore, it is possible to suppress the user visiting a facility for maintenance in the recommended period that is not the scheduled visit period for the maintenance corresponding to the specific item. That is, it is possible to determine a period that is suitable for the user to have the vehicle maintained.

Specific embodiments of the present disclosure will be described below with reference to the drawings. The hardware configuration, the module configuration, the functional configuration, etc. described in relation to the embodiments are not intended to limit the technical scope of the disclosure to only such embodiments unless specifically stated otherwise.

### First Embodiment

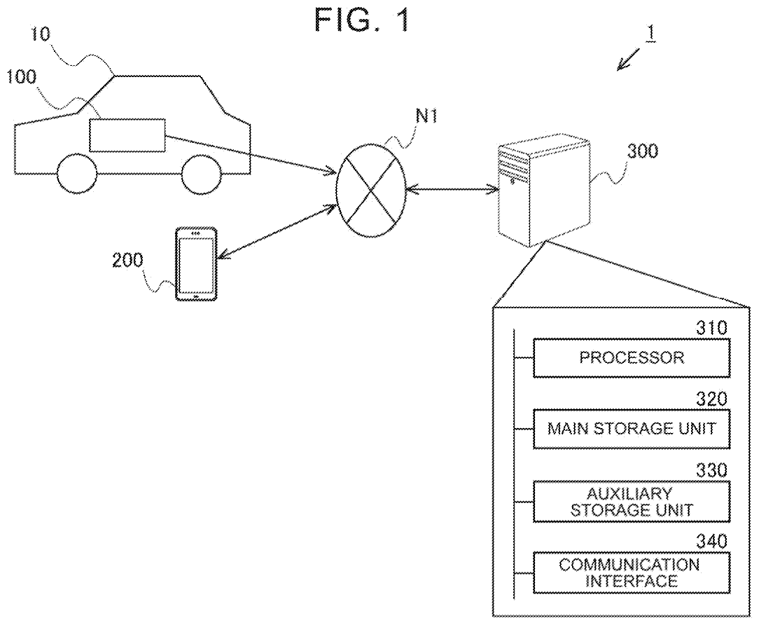

A notification system 1 according to the present embodiment will be described with reference to FIG. 1. FIG. 1 illustrates a schematic configuration of the notification system 1. The notification system 1 is configured to include an in-vehicle device 100, a user terminal 200, and a management server 300. In the notification system 1, the in-vehicle device 100, the user terminal 200, and the management server 300 are connected to each other through a network N1. The network N1 may be a wide area network (WAN) as a worldwide public communication network such as the Internet or a telephone communication network for mobile phones etc., for example.

### In-Vehicle Device

The in-vehicle device 100 is an in-vehicle device mounted on a vehicle 10. In the present embodiment, the vehicle 10 is a vehicle leased from a leasing company to a user. The in-vehicle device 100 acquires information (hereinafter occasionally referred to as “vehicle information”) on the travel status of the vehicle 10 from an electronic control unit that controls travel of the vehicle 10. The vehicle information includes a travel distance of the vehicle 10, for example. The in-vehicle device 100 transmits the vehicle information to the management server 300 via the network N1.

### Management Server

The management server 300 is a server device that manages a maintenance timing for the vehicle 10. The management server 300 acquires a date (hereinafter occasionally referred to as a “scheduled visit date”) on which the user of the vehicle 10 is scheduled to visit a facility (hereinafter occasionally referred to as a “maintenance facility”) at which the user can have the vehicle 10 maintained. When the vehicle 10 is a leased vehicle, the scheduled visit date may be a date on which the user performs procedures such as renewing a lease contract for the vehicle 10, for example. In this case, the maintenance facility is a business office etc. of a leasing company integrated with a maintenance shop. In addition, the scheduled visit date may be the date of a legal inspection for the vehicle 10 determined in advance, for example. In this case, the maintenance facility is a maintenance shop etc. at which a legal inspection is to be performed.

The management server 300 determines a maintenance item (hereinafter occasionally referred to as a “specific item”) for which it is recommended that maintenance should be performed, among a plurality of maintenance items for the vehicle 10, based on the travel distance of the vehicle 10 indicated in the vehicle information. The management server 300 also determines a recommended date on which it is recommended that maintenance corresponding to the specific item should be performed based on the travel distance of the vehicle 10 in the vehicle information. Here, the recommended date is not a date on which the deadline for maintenance corresponding to the specific item arrives. That is, the user of the vehicle 10 is not necessarily required to have the vehicle 10 undergo maintenance corresponding to the specific item on the recommended date. In the present embodiment, it is assumed that the user of the vehicle 10 is to visit the same maintenance facility on the recommended date as that to be visited on the scheduled visit date. The facility that the user is to visit on the scheduled visit date may be a facility that is different from the maintenance facility.

In the present embodiment, the scheduled visit period and the recommended period are each a period of one day. That is, the start periods of the scheduled visit date and the recommended date are the opening hour etc. of the maintenance facility on the scheduled visit date and the recommended date, respectively, for example. Meanwhile, the end periods of the scheduled visit date and the recommended date are the closing hour etc. of the maintenance facility on the scheduled visit date and the recommended date, respectively, for example. In the present embodiment, the fact that the scheduled visit period and the recommended period do not overlap each other indicates that the scheduled visit date and the recommended date are different. Alternatively, the fact that the scheduled visit period and the recommended period do not overlap each other may indicate that the scheduled visit date and the recommended date are the same date and occupy different time bands.

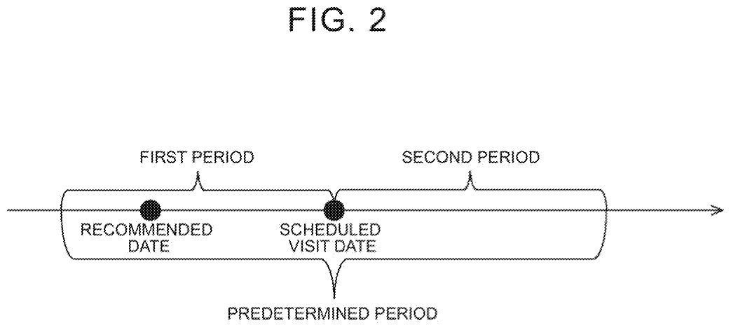

FIG. 2 is a first diagram illustrating a time line of the recommended date and the scheduled visit date. FIG. 2 illustrates a time line for a case where the recommended date arrives earlier than the scheduled visit date. As illustrated in FIG. 2, a predetermined period that includes the scheduled visit date is set on the time line. In the present embodiment, the predetermined period is a period determined in advance. A period from the start period of the predetermined period to the start period of the scheduled visit date is referred to as a “first period”. A period from the end period of the scheduled visit date to the end period of the predetermined period is referred to as a “second period”. In the present embodiment, the first period and the second period have the same length.

A case where it is recommended that the vehicle 10 should undergo maintenance corresponding to the specific item on the recommended date and where the user of the vehicle 10 has the vehicle 10 undergo maintenance corresponding to the specific item on the recommended date is assumed in FIG. 2. In this case, the scheduled visit date arrives after the user of the vehicle 10 has the vehicle 10 undergo maintenance corresponding to the specific item on the recommended date. Therefore, the user of the vehicle 10 is to visit the maintenance facility on the recommended date and the scheduled visit date. This requires the user of the vehicle 10 to visit the maintenance facility twice separately, which may be inconvenient for the user.

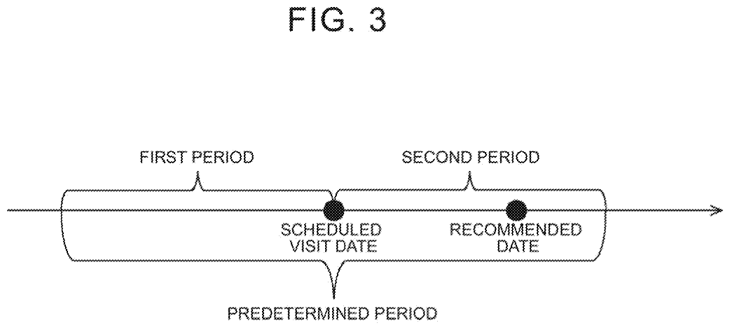

FIG. 3 is a second diagram illustrating a time line of the recommended date and the scheduled visit date. FIG. 3 illustrates a time line for a case where the recommended date arrives later than the scheduled visit date. Also in this case, a predetermined period is set as on the time line illustrated in FIG. 2.

Here, a case where it is recommended that the vehicle 10 should undergo maintenance corresponding to the specific item on the recommended date and where the user of the vehicle 10 has the vehicle 10 undergo maintenance corresponding to the specific item on the recommended date is assumed in FIG. 3. In this case, the recommended date arrives after the user of the vehicle 10 visits the maintenance facility on the scheduled visit date. Also in this case, the user of the vehicle 10 is required to visit the maintenance facility twice separately, which may be inconvenient for the user.

Thus, the management server 300 determines which of the scheduled visit date and the recommended date maintenance corresponding to the specific item is to be performed on based on a cost (hereinafter referred to as a “specific item maintenance cost”) for maintenance corresponding to the specific item. That is, the management server 300 determines a scheduled execution date for maintenance corresponding to the specific item as one of the scheduled visit date and the recommended date. The management server 300 transmits notification information to the user terminal 200 via the network N1. Here, the notification information is information for notifying the user of the scheduled execution date for maintenance corresponding to the specific item determined by the management server 300. In the present embodiment, the scheduled visit date and the recommended date are different dates. When the scheduled visit date and the recommended date are the same date, however, the management server 300 may transmit notification information notifying the user that the scheduled visit date (recommended date) is the scheduled execution date to the user terminal 200. A method for the management server 300 to determine which of the scheduled visit date and the recommended date maintenance corresponding to the specific item is to be performed on based on the specific item maintenance cost will be discussed in detail later.

The management server 300 is configured to include a computer that includes a processor 310, a main storage unit 320, an auxiliary storage unit 330, and a communication interface 340. The processor 310 is a central processing unit (CPU) or a digital signal processor (DSP), for example. The main storage unit 320 is a random access memory (RAM), for example. The auxiliary storage unit 330 is a read only memory (ROM), for example. Alternatively, the auxiliary storage unit 330 is a hard disk drive (HDD) or a disk storage medium such as a compact disc read only memory (CD-ROM), a digital versatile disc (DVD), or a Blu-ray disc, for example. Alternatively, the auxiliary storage unit 330 may be a removable medium (portable storage medium). Here, examples of the removable medium include a universal serial bus (USB) memory and a secure digital (SD) card. The communication interface 340 is a local area network (LAN) interface board or a wireless communication circuit for wireless communication, for example.

In the management server 300, the auxiliary storage unit 330 stores an operating system (OS), various programs, various information tables, etc. The management server 300 can implement various functions to be discussed later by the processor 310 loading the programs stored in the auxiliary storage unit 330 into the main storage unit 320 and executing the programs. However, some or all of the functions of the management server 300 may be implemented by a hardware circuit such as an application-specific integrated circuit (ASIC) or a field-programmable gate array (FPGA). It is not always necessary that the management server 300 should be implemented by a single physical component, and the management server 300 may be constituted by a plurality of computers that operate in conjunction with each other. The in-vehicle device 100 is also configured to include a computer as with the management server 300.

### User Terminal

The user terminal 200 is a terminal that is used by the user of the vehicle 10. Examples of the user terminal 200 include a computer, a portable information terminal, etc. that is used by the user of the vehicle 10. The user terminal 200 receives notification information from the management server 300 via the network N1. The user terminal 200 displays notification information for the user of the vehicle 10. This allows the user of the vehicle 10 to grasp the scheduled execution date for maintenance corresponding to the specific item. The user terminal 200 is also configured to include a computer as with the management server 300.

### Functional Configuration

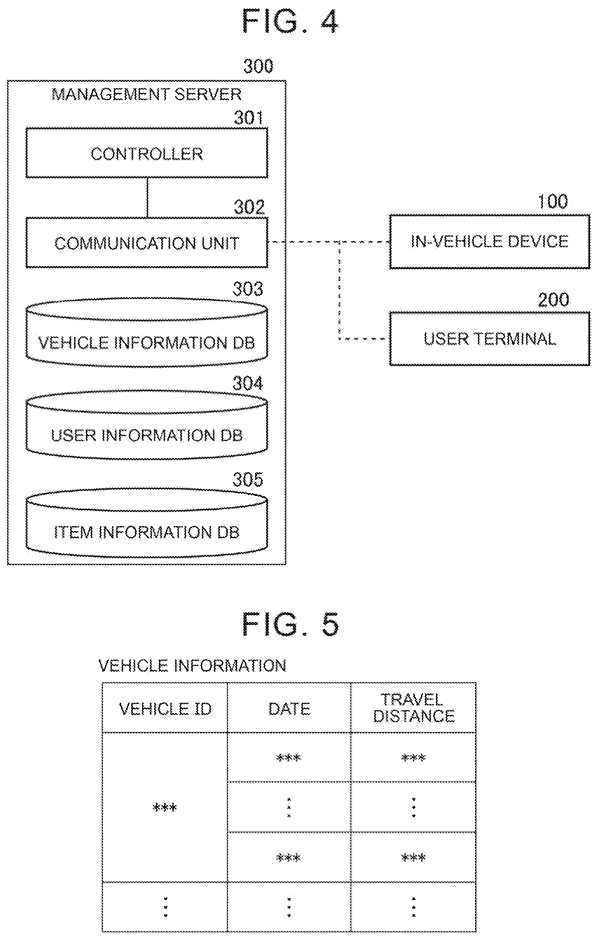

Next, the functional configuration of the management server 300 that constitutes the notification system I will be described with reference to FIGS. 4 to 7. FIG. 4 is a block diagram schematically illustrating an example of the functional configuration of the management server 300.

The management server 300 is configured to include a controller 301, a communication unit 302, a vehicle information database 303 (vehicle information DB 303), a user information database 304 (user information DB 304), and an item information database 305 (item information DB 305). The controller 301 has a function to perform arithmetic processing for controlling the management server 300. The controller 301 is implemented by the processor 310 of the management server 300. The communication unit 302 has a function to connect the management server 300 to the network N1. The communication unit 302 is implemented by the communication interface 340 of the management server 300.

The controller 301 receives vehicle information on the vehicle 10 from the in-vehicle device 100 via the communication unit 302. The controller 301 stores the received vehicle information in the vehicle information DB 303. The vehicle information DB 303 has a function to hold the vehicle information. The vehicle information DB 303 is implemented by the auxiliary storage unit 330 of the management server 300.

FIG. 5 illustrates an example of the configuration of a table for the vehicle information held in the vehicle information DB 303. As illustrated in FIG. 5, the vehicle information includes a vehicle identifier (ID) field, a date field, and a travel distance field. The vehicle ID field stores an identifier (vehicle ID) for specifying a vehicle. The vehicle ID field stores the vehicle ID of the vehicle 10. The date field stores information (dates) that indicates dates on which the vehicle traveled. The travel distance field stores information that indicates a distance (travel distance) over which the vehicle traveled on the date in the date field. Here, in the present embodiment, the vehicle information that the controller 301 receives from the in-vehicle device 100 includes information that indicates the distance traveled by the vehicle 10 in one day. The controller 301 stores information that indicates the travel distance in the travel distance field based on information that indicates the distance traveled by the vehicle 10 in one day. The controller 301 may specify a travel distance based on position information on the vehicle 10 received in real time from the in-vehicle device 100.

The user information DB 304 has a function to hold user information. The user information is information that includes a scheduled visit date on which the user is scheduled to visit a predetermined maintenance facility and a history of maintenance for the vehicle. The user information DB 304 is implemented by the auxiliary storage unit 330 of the management server 300.

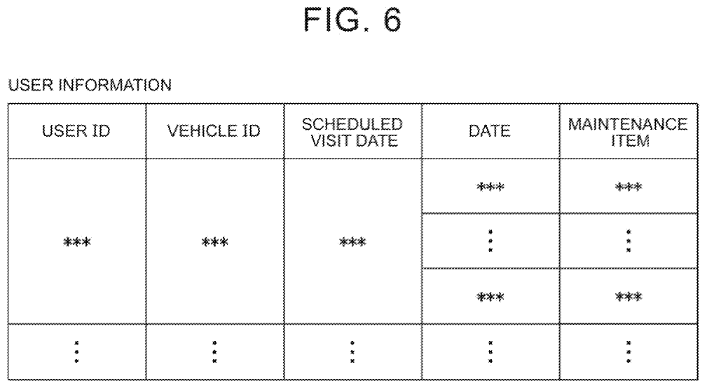

FIG. 6 illustrates an example of the configuration of a table for the user information held in the user information DB 304. As illustrated in FIG. 6, the user information includes a user ID field, a vehicle ID field, a scheduled visit date field, a date field, and a maintenance item field. The user ID field stores an identifier (user ID) for specifying a user. The user ID field stores the user ID of the user of the vehicle 10. The vehicle ID field stores an identifier (vehicle ID) for specifying a vehicle. The vehicle ID field stores the vehicle ID of the vehicle 10.

The scheduled visit date field stores information that indicates the scheduled visit date for the user of the user ID stored in the user ID field. The date field stores information (dates) that indicates dates on which the user of the user ID stored in the user ID field had the vehicle maintained in the past. The maintenance item field stores information that indicates maintenance items for which the vehicle was maintained on the dates in the date field. For example, the maintenance item field stores information indicating that tires of the vehicle were replaced. Alternatively, the maintenance item field stores information indicating that engine oil was changed, for example. Alternatively, the maintenance item field stores information indicating that a battery was replaced, for example.

The item information DB 305 has a function to hold item information. The item information is information that includes a travel distance for which it is recommended that maintenance corresponding to each maintenance item should be performed. The item information is also information that includes correlation between a maintenance item and the cost for the maintenance item and the importance degree of the maintenance item. The item information DB 305 is implemented by the auxiliary storage unit 330 of the management server 300.

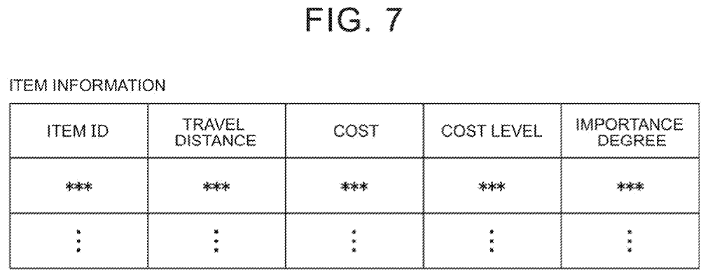

FIG. 7 illustrates an example of the configuration of a table for the item information held in the item information DB 305. As illustrated in FIG. 7, the item information includes an item ID field, a travel distance field, a cost field, a cost level field, and an importance degree Field. The item ID field stores an identifier (item ID) for specifying a maintenance item. The travel distance field stores information that indicates a travel distance to be traveled by the vehicle since maintenance corresponding to a maintenance item corresponding to the item ID is performed until it is recommended that maintenance corresponding to the maintenance item should be performed the next time. The cost field stores information that indicates a cost (maintenance cost) to be charged when maintenance corresponding to a maintenance item corresponding to the item ID stored in the item ID field is performed. The cost level field stores information that indicates the level of the maintenance cost in the cost field. The level of the maintenance cost is set so as to become higher as the maintenance cost is higher. The importance degree Field stores information that indicates the importance degree of a maintenance item corresponding to the item ID stored in the item ID field. Here, the importance degree is set so as to be higher for a maintenance item for which it is more likely that travel of the vehicle is adversely affected if maintenance is not performed.

The controller 301 determines a recommended date based on the vehicle information held in the vehicle information DB 303, the user information held in the user information DB 304, and the item information held in the item information DB 305. Specifically, the controller 301 acquires a travel distance of the vehicle 10 on each date from the vehicle information. The controller 301 calculates transitions in the travel distance of the vehicle 10 in the past from the travel distance of the vehicle 10 on each date. In addition, the controller 301 calculates a predicted value (hereinafter occasionally referred to simply as a “predicted travel distance value”) of the travel distance of the vehicle 10 in the future based on the transitions in the travel distance of the vehicle 10 in the past. A travel distance that the vehicle 10 is predicted to travel in one day is calculated as the predicted travel distance value. The predicted travel distance value is predicted by calculating an average value of the travel distance of the vehicle 10 in one day in the past based on the travel distance of the vehicle 10 on each date. A known method may be used as a method of calculating a predicted value of the travel distance of the vehicle 10 in the future.

The controller 301 calculates a travel distance of the vehicle 10 since the date on which maintenance corresponding to the maintenance item was performed until the present. In addition, the controller 301 adds the travel distance of the vehicle 10 since the date on which maintenance corresponding to the maintenance item was performed until the present and the predicted travel distance value to calculate a predicted value of the travel distance of the vehicle 10 calculated from the date on which such maintenance was performed. In addition, the controller 301 acquires a travel distance in the travel distance field in the item information. Then, the controller 301 determines the date on which the predicted value of the travel distance of the vehicle 10 calculated since from the date on which maintenance corresponding to the maintenance item was performed becomes equal to or more than the travel distance in the travel distance field in the item information as a recommended date. At this time, in addition, the controller 301 determines the maintenance item for which a recommended date is determined as a specific item.

In the present embodiment, the controller 301 determines a recommended date based on the travel distance of the vehicle 10. However, the controller 301 may determine a recommended date based on an element other than the travel distance of the vehicle 10. For example, the controller 301 may determine a recommended date based on information that indicates the status of degradation of a component of the vehicle 10 received from the in-vehicle device 100. The information that indicates the status of degradation of the vehicle 10 is generated based on a measurement value from a sensor mounted on the vehicle 10 to detect the status of degradation of the vehicle 10, for example. The sensor that detects the status of degradation of the vehicle 10 may be a sensor that detects dirt in engine oil etc., for example. Alternatively, the sensor that detects the status of degradation of the vehicle 10 may be a sensor that detects the remaining amount of a washer fluid of the vehicle 10, for example.

Alternatively, the controller may determine a date on which a certain number of days have elapsed since the preceding maintenance was performed as a recommended date based on the user information. In this case, the number of days that elapse for a recommended date to be determined may be different among the maintenance items.

The controller 301 acquires a scheduled visit date for the user of the vehicle 10 from the user information. In addition, the controller 301 determines whether the recommended date for the specific item is included within the predetermined period. When the recommended date for the specific item is included within the predetermined period, the controller 301 determines whether the recommended date arrives earlier than the scheduled visit date.

The controller 301 determines a scheduled execution date based on whether the recommended date arrives earlier than the scheduled visit date and the specific item maintenance cost. Here, a case where the recommended date arrives earlier than the scheduled visit date is assumed. That is, a case where the recommended date and the scheduled visit date arrive as the time line illustrated in FIG. 2 is assumed. In this case, a case where the specific item maintenance cost is equal to or more than a predetermined threshold is assumed. Here, the predetermined threshold is a value (amount of money) at which the maintenance cost is determined as high. If maintenance corresponding to the specific item is performed early when the specific item maintenance cost is equal to or more than the predetermined threshold, it is assumed that the timing of the next maintenance arrives early compared to a case where maintenance corresponding to the specific item is performed late. Thus, the controller 301 determines the scheduled execution date as the scheduled visit date when the recommended date arrives earlier than the scheduled visit date and the specific item maintenance cost is equal to or more than the predetermined threshold. Consequently, it is possible to suppress the maintenance cost for the vehicle 10. On the other hand, the controller 301 determines the scheduled execution date as the recommended date when the recommended date arrives earlier than the scheduled visit date and the specific item maintenance cost is less than the predetermined threshold.

Meanwhile, a case where the recommended date arrives later than the scheduled visit date is assumed. That is, a case where the recommended date and the scheduled visit date arrive as the time line illustrated in FIG. 3 is assumed. In this case, a case where the specific item maintenance cost is equal to or more than a predetermined threshold is assumed. As discussed above, if maintenance corresponding to the specific item is performed early when the specific item maintenance cost is equal to or more than the predetermined threshold, it is assumed that the timing of the next maintenance arrives early compared to a case where maintenance corresponding to the specific item is performed late. Thus, the controller 301 determines the scheduled execution date as the recommended date when the recommended date arrives later than the scheduled visit date and the specific item maintenance cost is equal to or more than the predetermined threshold. Consequently, it is possible to suppress the maintenance cost for the vehicle 10. On the other hand, the controller 301 determines the scheduled execution date as the scheduled visit date when the recommended date arrives later than the scheduled visit date and the specific item maintenance cost is less than the predetermined threshold.

In the present embodiment, the same threshold is used as the predetermined threshold, irrespective of whether the recommended date arrives earlier than the scheduled visit date. However, two different thresholds may be used for a case where the recommended date arrives earlier than the scheduled visit date and a case where the recommended date arrives later than the scheduled visit date.

When a scheduled execution date is determined, the controller 301 transmits notification information to the user terminal 200 via the communication unit 302. This allows the user of the vehicle 10 to grasp the scheduled execution date.

### Flowchart

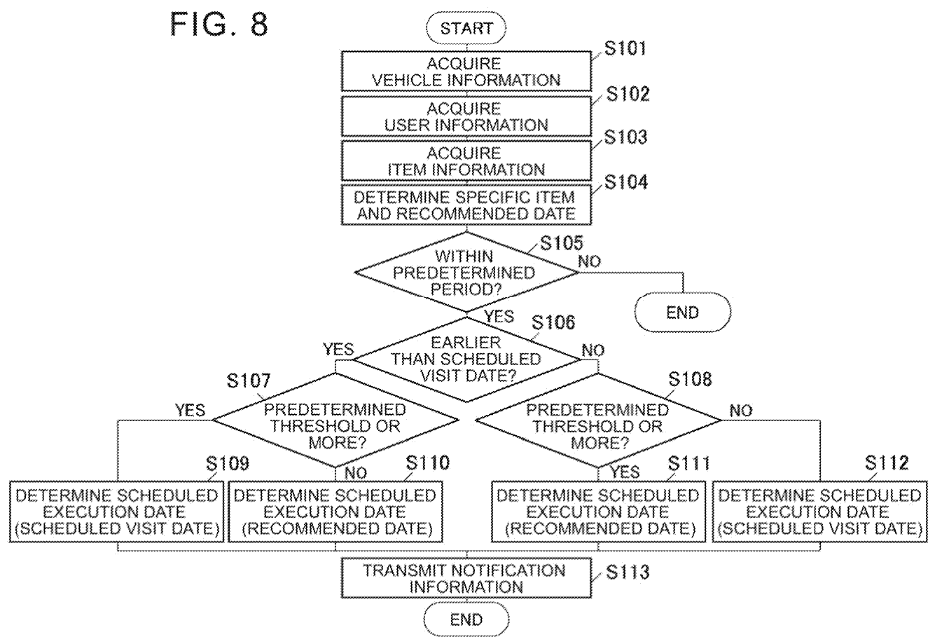

Next, a first process to be executed by the controller 301 of the management server 300 in the notification system 1 will be described with reference to FIG. 8. FIG. 8 is a flowchart of the first process to be executed by the controller 301. The first process is a process to determine which of the scheduled visit date and the recommended date the scheduled execution date for maintenance is set to. The process illustrated in FIG. 8 is executed at a predetermined timing. The predetermined timing may be a timing when a predetermined number of days have elapsed since the preceding execution of the process, for example.

In the first process illustrated in FIG. 8, first, in S101, vehicle information is acquired from the vehicle information DB 303. In S102, user information is acquired from the user information DB 304. In S103, item information is acquired from the item information DB 305. Next, in S104, a specific item and a recommended date are determined based on the vehicle information, the user information, and the item information.

Next, in S105, it is determined whether the recommended date for the specific item is included in a predetermined period. When a negative determination is made in S105, there is no specific item for which the recommended date arrives within the predetermined period, and therefore the first process is ended. When an affirmative determination is made in S105, it is determined in S106 whether the recommended date arrives earlier than the scheduled visit date.

When an affirmative determination is made in S106, it is determined in S107 whether the specific item maintenance cost is equal to or more than a predetermined threshold. When an affirmative determination is made in S107, the scheduled execution date is determined as the scheduled visit date in S109. Next, in S113, notification information notifying the user that the scheduled visit date is the scheduled execution date is transmitted to the user terminal 200. Then, the first process is ended. When a negative determination is made in S107, meanwhile, the scheduled execution date is determined as the recommended date in S110. Next, in S113, notification information notifying the user that the recommended date is the scheduled execution date is transmitted to the user terminal 200. Then, the first process is ended.

When a negative determination is made in S106, meanwhile, it is determined in S108 whether the specific item maintenance cost is equal to or more than a predetermined threshold. When an affirmative determination is made in S108, the scheduled execution date is determined as the recommended date in S111. Next, in S113, notification information notifying the user that the recommended date is the scheduled execution date is transmitted to the user terminal 200. Then, the first process is ended. When a negative determination is made in S108, meanwhile, the scheduled execution date is determined as the scheduled visit date in S112. Next, in S113, notification information notifying the user that the scheduled visit date is the scheduled execution date is transmitted to the user terminal 200. Then, the first process is ended.

As described above, the notification system 1 according to the present embodiment determines whether the scheduled execution date for maintenance corresponding to the specific item is set to the scheduled visit date or set to the recommended date.

Consequently, the date on which maintenance corresponding to the specific item is performed may be delayed (or advanced) from the recommended date to the scheduled visit date, for example. In this case, it is possible to suppress the user having to visit the maintenance facility on a date other than the scheduled visit date just for maintenance corresponding to the specific item.

In the present embodiment, in addition, when the maintenance cost is equal to or more than a predetermined threshold, the scheduled execution date for maintenance corresponding to the specific item is determined as one of the scheduled visit date and the recommended date that arrives the later. Consequently, it is possible to reduce the burden of the maintenance cost on the user. In this manner, it is possible to determine a date that is suitable for the user to have the vehicle 10 maintained.

### First Modification

In the present modification, the predetermined period is determined such that the length of the first period in the predetermined period becomes longer as the specific item maintenance cost is higher. Only differences from the first embodiment will be described below.

After a recommended date is determined, the controller 301 determines whether the recommended date is included in a predetermined period. At this time, the controller 301 sets the first period based on the cost level for the specific item in the item information held in the item information DB 305. Here, the length of the first period is associated with each cost level, and the controller 301 sets the first period based on such association. At this time, the second period may be a fixed period. Then, the controller 301 determines whether the recommended date is included in the predetermined period determined by the first period and the second period.

In the present modification, the predetermined period is determined such that the length of the first period in the predetermined period becomes longer as the specific item maintenance cost is higher. Consequently, it is more likely that a specific item for which the recommended date arrives earlier than the scheduled visit date and the maintenance cost for which is high is included in the predetermined period. This makes it more likely that the scheduled execution date for maintenance corresponding to a specific item for which the recommended date arrives earlier than the scheduled visit date and for which the maintenance cost is high is determined as the scheduled visit date. As a result, it is possible to further suppress the burden of the maintenance cost on the user.

### Second Embodiment

In the first embodiment, the scheduled execution date is determined based on the specific item maintenance cost. In the present embodiment, on the other hand, the scheduled execution date is determined based on the importance degree of maintenance for the specific item. Only differences from the first embodiment will be described below.

The controller 301 acquires an importance degree of the specific item from the item information held in the item information DB 305. The controller 301 determines whether the importance degree of the specific item is equal to or more than a predetermined threshold. Here, the predetermined threshold is set to an importance degree at which it is assumed that there is a certain possibility or more that travel of the vehicle is adversely affected if maintenance corresponding to the specific item is not performed.

At this time, it is assumed that the safety of the vehicle 10 may not be secured if maintenance corresponding to the specific item is performed late, compared to a case where such maintenance is performed early, when the importance degree of maintenance corresponding to the specific item is equal to or more than the predetermined threshold. Thus, the controller 301 determines the scheduled execution date as the recommended date when the recommended date arrives earlier than the scheduled visit date and the importance degree of maintenance corresponding to the specific item is equal to or more than the predetermined threshold. Consequently, maintenance corresponding to the specific item is performed earlier than the scheduled visit date, which secures the safety of the vehicle. On the other hand, the controller 301 determines the scheduled execution date as the scheduled visit date when the recommended date arrives earlier than the scheduled visit date and the importance degree of maintenance corresponding to the specific item is less than the predetermined threshold.

When the recommended date arrives later than the scheduled visit date and the importance degree of maintenance corresponding to the specific item is equal to or more than the predetermined threshold, meanwhile, the scheduled execution date is determined as the scheduled visit date. Consequently, maintenance corresponding to the specific item is performed earlier than the recommended date, which secures the safety of the vehicle. On the other hand, the controller 301 determines the scheduled execution date as the recommended date when the recommended date arrives later than the scheduled visit date and the importance degree of maintenance corresponding to the specific item is less than the predetermined threshold.

### Flowchart

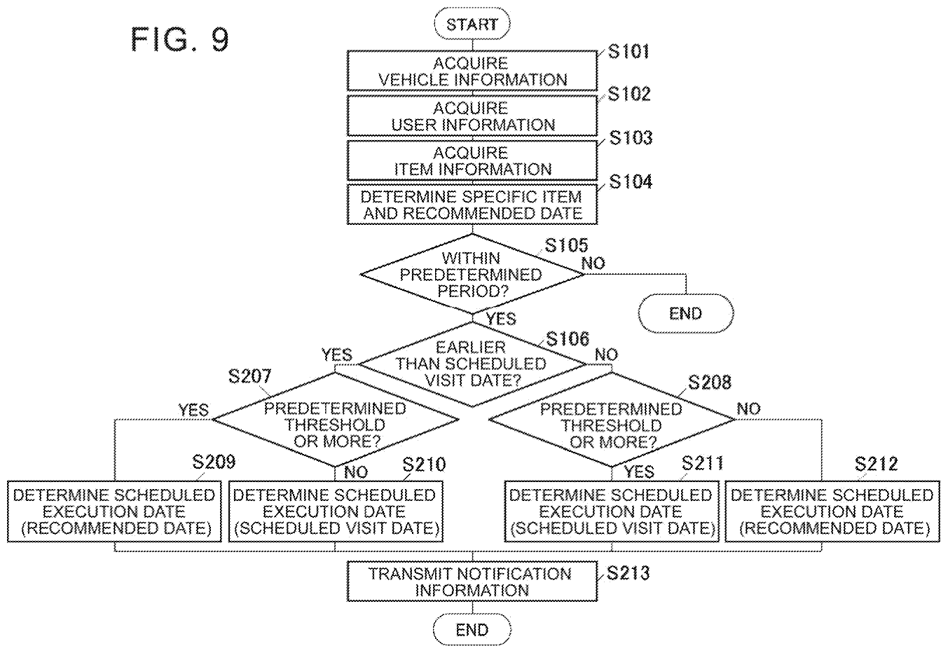

Next, a second process to be executed by the controller 301 of the management server 300 in the notification system I will be described with reference to FIG. 9. FIG. 9 is a flowchart of the second process to be executed by the controller 301. The second process is a process to determine which of the scheduled visit date and the recommended date the scheduled execution date is set to. The process illustrated in FIG. 9 is executed at a predetermined timing. The predetermined timing may be a timing when a predetermined number of days have elapsed since the preceding execution of the process, for example. Here, the processes in S101 to S106 illustrated in FIG. 9 are the same as the processes in S101 to S106 illustrated in FIG. 8, and therefore are not described.

In the second process illustrated in FIG. 9, when an affirmative determination is made in S106, it is determined in S207 whether the importance degree of maintenance corresponding to the specific item is equal to or more than a predetermined threshold. When an affirmative determination is made in S207, the scheduled execution date is determined as the recommended date in S209. Next, in S213, notification information notifying the user that the recommended date is the scheduled execution date is transmitted to the user terminal 200. Then, the second process is ended. When a negative determination is made in S207, meanwhile, the scheduled execution date is determined as the scheduled visit date in S210. Next, in S213, notification information notifying the user that the scheduled visit date is the scheduled execution date is transmitted to the user terminal 200. Then, the second process is ended.

When a negative determination is made in S106, meanwhile, it is determined in S208 whether the importance degree of maintenance corresponding to the specific item is equal to or more than a predetermined threshold. When an affirmative determination is made in S208, the scheduled execution date is determined as the scheduled visit date in S211. Next, in S213, notification information notifying the user that the scheduled visit date is the scheduled execution date is transmitted to the user terminal 200. Then, the second process is ended. When a negative determination is made in S208, meanwhile, the scheduled execution date is determined as the recommended date in S212. Next, in S213, notification information notifying the user that the recommended date is the scheduled execution date is transmitted to the user terminal 200. Then, the second process is ended.

As described above, the notification system 1 according to the present embodiment determines whether the scheduled execution date for maintenance corresponding to the specific item is set to the scheduled visit date or set to the recommended date. Consequently, the number of visits to the maintenance facility by the user can be reduced as in the first embodiment.

In the present embodiment, in addition, when the importance degree of maintenance is equal to or more than a predetermined threshold, the scheduled execution date for maintenance corresponding to the specific item is determined as one of the scheduled visit date and the recommended date that arrives the earlier. Consequently, the safety of the vehicle 10 can be further enhanced. In this manner, it is possible to determine a date that is suitable for the user to have the vehicle 10 maintained.

### Second Modification

In the present modification, the predetermined period is determined such that the length of the second period in the predetermined period becomes longer as the importance degree of maintenance corresponding to the specific item is higher. Only differences from the second embodiment will be described below.

After a recommended date is determined, the controller 301 determines whether the recommended date is included in a predetermined period. At this time, the controller 301 sets the second period based on the importance degree of maintenance for the specific item in the item information held in the item information DB 305. Here, the length of the second period is associated with each importance degree of maintenance, and the controller 301 sets the second period based on such association. At this time, the first period may be a fixed period. Then, the controller 301 determines whether the recommended date is included in the predetermined period determined by the first period and the second period.

In the present modification, the predetermined period is determined such that the length of the second period in the predetermined period becomes longer as the importance degree of maintenance corresponding to the specific item is higher. Consequently, it is more likely that a specific item for which the recommended date arrives later than the scheduled visit date and for which the importance degree of maintenance is high is included in the predetermined period. This makes it more likely that the scheduled execution date for maintenance corresponding to a specific item for which the recommended date arrives later than the scheduled visit date and for which the importance degree of maintenance is high is determined as the scheduled visit date. As a result, the safety of the vehicle 10 can be further enhanced.

### Third Embodiment

In the present embodiment, the management server 300 acquires a scheduled visit period within which the user is scheduled to visit the maintenance facility. In the present embodiment, in addition, the management server 300 determines a recommended period as a period in which it is recommended that maintenance corresponding to the specific item should be performed. When the recommended period for the specific item is included within the predetermined period including the scheduled visit period, the management server 300 determines which of the scheduled visit period and the recommended period maintenance corresponding to the specific item is to be performed in. Only differences from the first embodiment and the second embodiment will be described below.

The user information held in the user information DB 304 includes a scheduled visit period field in place of the scheduled visit date field. The scheduled visit period field stores information that indicates a scheduled visit period. The scheduled visit period may be a period in which the user is scheduled to perform procedures such as renewing a lease contract for the vehicle 10, for example. Alternatively, the scheduled visit period may be a period within which the vehicle 10 is determined to undergo a legal inspection, for example.

The controller 301 determines a recommended period based on the vehicle information held in the vehicle information DB 303, the user information held in the user information DB 304, and the item information held in the item information DB 305. Specifically, the controller 301 determines a recommended date by the same method as in the first embodiment. Then, the controller 301 determines a recommended period so as to include a recommended date. Here, the controller 301 determines a date a certain number of days before the recommended date as the start period of the recommended period, for example. In addition, the controller 301 determines a date a certain number of days after the recommended date as the end period of the recommended period, for example.

The controller 301 determines whether the recommended period for the specific item is included within the predetermined period. Here, the controller 301 may make an affirmative determination when a part of the recommended period is included within the predetermined period. Alternatively, the controller 301 may make an affirmative determination when all of the recommended period is included within the predetermined period. When the recommended period is included within the predetermined period, the controller 301 determines whether the recommended period arrives earlier than the scheduled visit period.

At this time, the predetermined period may be determined such that the length of a period before the start period of the scheduled visit period becomes longer as the maintenance cost for the specific item is higher. Consequently, it is possible to further suppress the burden of the maintenance cost on the user. In addition, the predetermined period may be determined such that the length of a period after the end period of the scheduled visit period becomes longer as the importance degree of maintenance for the specific item is higher. Consequently, the safety of the vehicle 10 can be further enhanced.

The controller 301 determines the scheduled execution period based on whether the recommended period arrives earlier than the scheduled visit period and the maintenance cost for the specific item. At this time, the controller 301 determines the scheduled execution period as the scheduled visit period when the recommended period arrives earlier than the scheduled visit period and the maintenance cost for the specific item is equal to or more than the predetermined threshold. The controller 301 determines the scheduled execution period as the recommended period when the recommended period arrives earlier than the scheduled visit period and the maintenance cost for the specific item is less than the predetermined threshold. In addition, the controller 301 determines the scheduled execution period as the recommended period when the recommended period arrives later than the scheduled visit period and the maintenance cost for the specific item is equal to or more than the predetermined threshold. Meanwhile, the controller 301 determines the scheduled execution period as the scheduled visit period when the recommended period arrives later than the scheduled visit period and the maintenance cost for the specific item is less than the predetermined threshold.

Alternatively, the controller 301 may determine the scheduled execution period based on whether the recommended period arrives earlier than the scheduled visit period and the importance degree of maintenance for the specific item. At this time, the controller 301 determines the scheduled execution period as the recommended period when the recommended period arrives earlier than the scheduled visit period and the importance degree of maintenance for the specific item is equal to or more than the predetermined threshold. The controller 301 determines the scheduled execution period as the scheduled visit period when the recommended period arrives earlier than the scheduled visit period and the importance degree of maintenance for the specific item is less than the predetermined threshold. In addition, the controller 301 determines the scheduled execution period as the scheduled visit period when the recommended period arrives later than the scheduled visit period and the importance degree of maintenance for the specific item is equal to or more than the predetermined threshold. In addition, the controller 301 determines the scheduled execution period as the recommended period when the recommended period arrives later than the scheduled visit period and the importance degree of maintenance for the specific item is less than the predetermined threshold.

In the present embodiment, the scheduled visit period and the recommended period do not overlap each other. When the scheduled visit period and the recommended period overlap each other, however, the management server 300 may determine a period for which the scheduled visit period and the recommended period overlap each other as the scheduled execution period. In this case, the management server 300 transmits notification information notifying the user that the scheduled execution period is a period for which the scheduled visit period and the recommended period overlap each other to the user terminal 200.

In the present embodiment, as described above, the scheduled visit period and the recommended period are each a period that includes a plurality of days, unlike the first embodiment in which the scheduled visit period and the recommended period are each a period of a single day. Also in such a case, it is possible to determine a period that is suitable for the user to have the vehicle 10 maintained.

### Other Embodiments

The embodiments discussed above are merely exemplary, and the present disclosure may be modified as appropriate without departing from the spirit and scope of the present disclosure. The processes and means described in the present disclosure may be combined as desired unless any technical contradiction occurs.

The processes described as being performed by a single device may be executed in a distributed manner by a plurality of devices. Alternatively, the processes described as being performed by different devices may be executed by a single device. In a computer system, the hardware configuration (server configuration) that implements functions can be changed flexibly.

The present disclosure can also be implemented by supplying a computer with a computer program that implements the functions described in relation to the above embodiments and causing one or more processors of the computer to read and execute the program. Such a computer program may be provided to the computer through a non-transitory computer-readable storage medium that is connectable to a system bus of the computer, or may be provided to the computer via a network. Examples of the non-transitory computer-readable storage medium include any type of disk or disc such as a magnetic disk (floppy (registered trademark) disk, hard disk drive (HDD), etc.) and an optical disc (CD-ROM, DVD, Blu-ray disc, etc.), and any type of medium suitable for storing electronic instructions such as a read only memory (ROM), a random access memory (RAM), an erasable programmable read only memory (EPROM), an electrically erasable programmable read only memory (EEPROM), a magnetic card, a flash memory, and an optical card.

What is claimed is:

1. An information processing device comprising a controller configured to:
acquire a scheduled visit period in which a user is scheduled to visit a facility at which the user is able to have a vehicle maintained;
determine whether a specific item is present among a plurality of maintenance items for the vehicle, the specific item being a maintenance item for which a recommended period in which it is recommended to have the vehicle maintained is included within a predetermined period that includes the scheduled visit period, and the recommended period being a period that does not overlap the scheduled visit period;
acquire item information about a maintenance content of the specific item when the specific item is present; and
determine, based on the item information, whether maintenance corresponding to the specific item is to be performed in the scheduled visit period or in the recommended period.

2. The information processing device according to claim 1, wherein:
the item information includes information on a maintenance cost required for the maintenance corresponding to the specific item; and
the controller is configured to, in a case where the recommended period arrives earlier than the scheduled visit period,
determine to perform the maintenance corresponding to the specific item in the scheduled visit period when the maintenance cost is equal to or more than a first threshold, and
determine to perform the maintenance corresponding to the specific item in the recommended period when the maintenance cost is less than the first threshold.

3. The information processing device according to claim 2, wherein the predetermined period is set such that a length of a period before a start period of the scheduled visit period is longer as the maintenance cost is higher.

4. The information processing device according to claim 1, wherein:
the item information includes information on a maintenance cost required for the maintenance corresponding to the specific item; and
the controller is configured to, in a case where the recommended period arrives later than the scheduled visit period,
determine to perform the maintenance corresponding to the specific item in the recommended period when the maintenance cost is equal to or more than a second threshold, and
determine to perform the maintenance for the specific item in the scheduled visit period when the maintenance cost is less than the second threshold.

5. The information processing device according to claim 1, wherein:
the item information includes information on an importance degree of the maintenance corresponding to the specific item; and
the controller is configured to, in a case where the recommended period arrives earlier than the scheduled visit period,
determine to perform the maintenance corresponding to the specific item in the recommended period when the importance degree is equal to or more than a third threshold, and
determine to perform the maintenance corresponding to the specific item in the scheduled visit period when the importance degree is less than the third threshold.

6. The information processing device according to claim 1, wherein:
the item information includes information on an importance degree of the maintenance corresponding to the specific item; and
the controller is configured to, in a case where the recommended period arrives later than the scheduled visit period,
determine to perform the maintenance corresponding to the specific item in the scheduled visit period when the importance degree is equal to or more than a fourth threshold, and
determine to perform the maintenance corresponding to the specific item in the recommended period when the importance degree is less than the fourth threshold.

7. The information processing device according to claim 6, wherein the predetermined period is set such that a length of a period after an end period of the scheduled visit period is longer as the importance degree is higher.

8. The information processing device according to claim 1, wherein the scheduled visit period is a period in which the vehicle is defined to undergo a legal inspection.

9. The information processing device according to claim 1, wherein:
the vehicle is a vehicle leased from a leasing company to the user; and
the scheduled visit period is a period in which the user is scheduled to bring the vehicle to a facility associated with the leasing company.

10. An information processing method to be executed by a computer, the information processing method comprising:
acquiring a scheduled visit period in which a user is scheduled to visit a facility at which the user is able to have a vehicle maintained;
determining whether a specific item is present among a plurality of maintenance items for the vehicle, the specific item being a maintenance item for which a recommended period in which it is recommended to have the vehicle maintained is included within a predetermined period that includes the scheduled visit period, and the recommended period being a period that does not overlap the scheduled visit period;
acquiring item information about a maintenance content of the specific item when the specific item is present; and
determining, based on the item information, whether maintenance corresponding to the specific item is to be performed in the scheduled visit period or in the recommended period.

11. The information processing method according to claim 10, wherein:
the item information includes information on a maintenance cost required for the maintenance corresponding to the specific item; and
the determining whether maintenance corresponding to the specific item is to be performed in the scheduled visit period or in the recommended period includes, in a case where the recommended period arrives earlier than the scheduled visit period,
determining to perform the maintenance corresponding to the specific item in the scheduled visit period when the maintenance cost is equal to or more than a first threshold, and
determining to perform the maintenance corresponding to the specific item in the recommended period when the maintenance cost is less than the first threshold.

12. The information processing method according to claim 11, wherein the predetermined period is set such that a length of a period before a start period of the scheduled visit period is longer as the maintenance cost is higher.

13. The information processing method according to claim 10, wherein:
the item information includes information on a maintenance cost required for the maintenance corresponding to the specific item; and
the determining whether maintenance corresponding to the specific item is to be performed in the scheduled visit period or in the recommended period includes, in a case where the recommended period arrives later than the scheduled visit period,
determining to perform the maintenance corresponding to the specific item in the recommended period when the maintenance cost is equal to or more than a second threshold, and
determining to perform the maintenance for the specific item in the scheduled visit period when the maintenance cost is less than the second threshold.

14. The information processing method according to claim 10, wherein:
the item information includes information on an importance degree of the maintenance corresponding to the specific item; and
the determining whether maintenance corresponding to the specific item is to be performed in the scheduled visit period or in the recommended period includes, in a case where the recommended period arrives earlier than the scheduled visit period,
determining to perform the maintenance corresponding to the specific item in the recommended period when the importance degree is equal to or more than a third threshold, and
determining to perform the maintenance corresponding to the specific item in the scheduled visit period when the importance degree is less than the third threshold.

15. The information processing method according to claim 10, wherein:
the item information includes information on an importance degree of the maintenance corresponding to the specific item; and
the determining of whether maintenance corresponding to the specific item is to be performed in the scheduled visit period or in the recommended period includes, in a case where the recommended period arrives later than the scheduled visit period,
determining to perform the maintenance corresponding to the specific item in the scheduled visit period when the importance degree is equal to or more than a fourth threshold, and
determining to perform the maintenance corresponding to the specific item in the recommended period when the importance degree is less than the fourth threshold.

16. The information processing method according to claim 15, wherein the predetermined period is set such that a length of a period after an end period of the scheduled visit period is longer as the importance degree is higher.

17. The information processing method according to claim 10, wherein the scheduled visit period is a period in which the vehicle is defined to undergo a legal inspection.

18. The information processing method according to claim 10, wherein:
the vehicle is a vehicle leased from a leasing company to the user; and
the scheduled visit period is a period in which the user is scheduled to bring the vehicle to a facility associated with the leasing company.

19. A non-transitory storage medium storing instructions that are executable by one or more processors and that cause the one or more processors to execute functions comprising:
acquiring a scheduled visit period in which a user is scheduled to visit a facility at which the user is able to have a vehicle maintained;
determining whether a specific item is present among a plurality of maintenance items for the vehicle, the specific item being a maintenance item for which a recommended period in which it is recommended to have the vehicle maintained is included within a predetermined period that includes the scheduled visit period, and the recommended period being a period that does not overlap the scheduled visit period;
acquiring item information about a maintenance content of the specific item when the specific item is present; and
determining, based on the item information, whether maintenance corresponding to the specific item is to be performed in the scheduled visit period or in the recommended period.

20. The non-transitory storage medium according to claim 19, wherein:
the item information includes information on a maintenance cost required for the maintenance corresponding to the specific item; and
the determining of whether maintenance corresponding to the specific item is to be performed in the scheduled visit period or in the recommended period includes, in a case where the recommended period arrives earlier than the scheduled visit period,
determining to perform the maintenance corresponding to the specific item in the scheduled visit period when the maintenance cost is equal to or more than a first threshold, and
determining to perform the maintenance corresponding to the specific item in the recommended period when the maintenance cost is less than the first threshold.
